(19) United States
(12) Patent Application Publication
(10) Pub. No.: US 2016/0232599 A1
(43) Pub. Date: Aug. 11, 2016

(54) SYSTEM FOR ENHANCING SELECTION OF ITEMS

(71) Applicant: APOLLO ENTERPRISE SOLUTIONS, LTD., Long Beach, CA (US)

(72) Inventor: Gluck Adrian, Long Beach, CA (US)

(21) Appl. No.: 14/904,071

(22) PCT Filed: Oct. 28, 2013
(86) PCT No.: PCT/US2013/067055

§ 371 Date: Jan. 8, 2016

(51) Int. Cl. G06Q 30/06; G06F 3/0484

(52) U.S. Cl. CPC G06Q 30/0641; G06F 3/04842

(57) ABSTRACT

A system and method for facilitating user selection of items is provided. The design determines psychographic factors of a user, categorizes the user as belonging to a psychographic group based on determined psychographic factors of the use, determines a preferred arrangement of items directed to the user based on the user belonging to the psychographic group, and provides the preferred arrangement of items to the user.

### BACKGROUND OF THE INVENTION

1. Field of the Invention

The present invention relates in general to systems and methods for enhancing consumer selections, and more particularly to a system and method for enhancing choices and selections made by consumers in arrangements such as an online purchasing arrangement.

2. Description of the Related Art

In the internet age, people are constantly making decisions regarding purchases—blue or black, Company X or Company Y, big or small, highly rated or low cost, and so forth. Economists view consumers as driven by their pursuit of self-interest, with their individual choices in the marketplace providing information and all measurements needed to reveal their preferences. If at the end of the day you buy the toaster from company Z having cost X based on 27 positive recommendations, and you choose the silver toaster rather than the white one after looking at toasters for 23 minutes, you have indicated a number of quantitative values and a great deal of information about how you selected your purchase.

Current systems typically provide selections based either on predetermined arrangements, such as static arrangements, or arrangements selectively ordered in some manner, such as most popular, lowest price, highest likelihood of matching the phrase entered, most lucrative for the seller(s), or some other arrangement. However, certain people are motivated by price, while others are motivated by ratings, while still others are motivated by the ability of the purchase to satisfy a particular, unspoken need. It can be difficult to place the right product or selection in front of the right individual, particularly when only a limited number, say three or four, selections are presented on a single screen to a user. With the limited amount of time people spend on web sites, it would be beneficial to present each user with a set of choices directed to selections most closely matching his or her interests, wants, and/or needs.

In light of the above, it would be desirable to have a system and method that improves online selection of goods and services over systems and methods previously employed for such purposes.

### SUMMARY OF THE INVENTION

According to one aspect of the present design, there is provided a system and method for facilitating user selection of items. The design determines psychographic factors of a user, categorizes the user as belonging to a psychographic group based on determined psychographic factors of the use, determines a preferred arrangement of items directed to the user based on the user belonging to the psychographic group, and provides the preferred arrangement of items to the user.

These and other advantages of the present invention will become apparent to those skilled in the art from the following detailed description of the invention and the accompanying drawings.

### BRIEF DESCRIPTION OF THE DRAWINGS

For a more complete understanding of the present disclosure, reference is now made to the following figures, wherein like reference numbers refer to similar items throughout the figures:

FIG. 1 illustrates a computer system for use in accordance with one embodiment of the present design;

FIG. 2 is a general representation of the operation of the present design; and

FIG. 3 includes a representation of a psychographic module in accordance with the present design.

### DETAILED DESCRIPTION OF THE INVENTION

The following description and the drawings illustrate specific embodiments sufficiently to enable those skilled in the art to practice the system and method described. Other embodiments may incorporate structural, logical, process and other changes. Examples merely typify possible variations. Individual components and functions are generally optional unless explicitly required, and the sequence of operations may vary. Portions and features of some embodiments may be included in or substituted for those of others.

In general, the present design includes a system and method for assessing psychographic traits of users, either as groups or individually, and arranging and providing selections in a preferred manner based on a known trait or traits (psychographic factors) of an actual individual or a target (hypothetical) individual.

The present design features functionality including identifying personality traits of an individual or individuals, characterizing and/or grouping characteristics or traits, and associating those traits with desired choices or selections. The present design further offers choices or selections, including but not limited to products or services, in a manner designed to appeal to one or more psychographic groups by identifying a choice or selection, identifying a target market, determining psychographic groups belonging to the target market, determining whether a user or group of users belongs to the psychographic group, and preparing an arrangement or presentation seeking to target maximum interest among persons in the psychographic group.

As a separate function, the present design may take a person or persons and provide them with a series of queries intended to determine a psychographic profile for the person. Alternately, or in addition, the system may observe behavior in some manner, such as observing online activity or obtaining online activity maintained on a user device, and may seek to categorize or classify the user as belonging to a particular psychographic group. Once the user is classified as belonging to a psychographic group, the system determines an appropriate arrangement or collection or display for the user based on her characteristics.

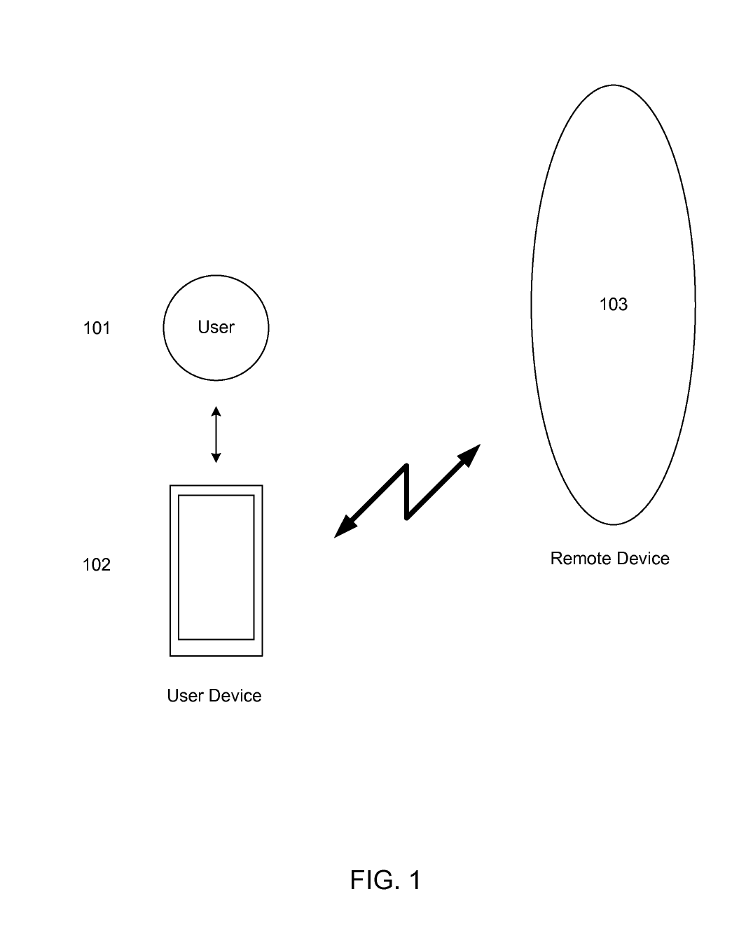

The entirety of the present system is illustrated in FIG. 1. From FIG. 1, user 101 interfaces with user device 102 which may collect information about the user and may transmit that information to remote device 103. Remote device 103 may be any arrangement known in the art that offers online computational functionality, including but not limited to a server or server arrangement, the Internet “cloud,” or other devices. Other user devices may be employed, and each user device offers internet connectivity, whether by wire or wireless connection or some combination or any other means known to those skilled in the art, to remote device 103. The functionality called for herein may be executed over multiple devices forming remote device 103 and is not limited to a single device. The functionality called for by remote device 103 may be performed on a single device, however, or any combination of devices.

Operation of the present design calls for determining psychographic groups as well as classifying or characterizing users or potential users as belonging to one or more psychographic groups. As noted, two general options are available: determining a psychographic group or groups for a user and providing the information in a preferred arrangement or preferred display for the particular group or groups to which the user belongs, or making a determination of the goods or services being offered and deciding the most likely display or arrangement that is considered to appeal to users of the site, i.e. users belonging to a known psychographic group. Thus the present design may generally be considered as making a determination on the buyer (user) side or on the seller (remote) side, and seeking to display the goods or services in a most attractive manner irrespective of how the determination was made. The system may also use a combination of buyer side and seller side determinations to decide how the goods or services are preferably displayed.

Psychographic determinations originate from observations from fields including cognitive psychology, anthropology, evolutionary biology, and neurology that many external factors are at work when people make decisions. From a marketing perspective, that is, from the perspective of product marketers wishing to attract and keep customers, many of these factors can be understood and measured through psychographics. Technically speaking, psychographics is the study of personality, values, attitudes, interests, and lifestyles of customers. The focus on interests, activities, and opinions results in psychographic factors being in some circles called “IAO” variables. A relatively complete profile of a person or group's psychographic make-up is called a “psychographic profile”. Psychographic profiles are used in market segmentation as well as in advertising. Categories of psychographic factors used in market segmentation include interests, activities, and opinions (IAOs), attitudes, values, and behavior.

Relatively predictable universal human behaviors affect the process people use to make choices. Such behaviors affect the manner in which people go through the mental process of judging the merits of multiple choices and selecting one choice from among those offered.

The present design is a system and method taking into account the psychographic profile of users making online selections of products or services (frequently called “products” herein. Use of the word “products” may mean products alone or products and services and is thus intended broadly). The present design either helps users make optimum choices (e.g. select a best product, pay a least amount of money, etc.), or helps the choices provider maximize its objectives (e.g. maximize sales, maximize profits, minimize losses, etc.), or both.

The present design thus accounts for a psychographic profile of each user and determines a number of selection choices presented to each customer, actionable elements of each selection, wording of the choices (words difficulty, tone of voice, etc.), and/or order in which the choices are presented,

The following is a non-exhaustive list of psychographic elements that can be considered when creating selection choices to be presented to a user:

Agoraphobia—Many people find making choice uncomfortable, and often use procrastination, rules, pre-commitment, habit, suspicion, and imitation to avoid “rational” decision-making and trade. In the present design, the user may be put at ease by providing clear and simple explanations for each selection, such as what the selection means, why the selection is offered, what will happen if that selection is chosen, and how to decide which selection to choose.

“Live to Work”—These users “live to work” so that they can earn monetary rewards and attain higher status. Their goal is to win. This may be a cultural attribute; certain cultures do not “live to work” and such attributes may be rarely found. The system and the choices presented and the psychographic profile may reflect this cultural information.

Newness—Certain persons have a high degree of acceptance for new ideas, innovative products and a willingness to try something new or different, especially as it pertains to technology and business practices. Again, such a psychographic group may have a cultural component for example, certain cultures may exhibit little willingness to try new ideas. It is to be understood that such cultural attributes are or may be tendencies determined by observation, and may not apply for certain users. For example, a user who works a great deal, i.e. “lives to work,” may be a member of a culture that does not exhibit a “live to work” tendency. Each culture tends to have differences from other cultures, and such attributes may be taken into account. For example, a user seeking goods or services from a European location or Internet provider may be believed to exhibit general behavioral tendencies in accordance with persons in the particular country.

Availability Bias—People give preference to information and events that come easily to mind either because they are more recent, were observed personally, and/or were more memorable than other events.

Choices Sequence—People prefer to make quick decisions by picking smaller or simpler choices first, and by choosing sensible default options.

Cognitive Control—People are continually flooded with information about what is rewarding around them—the things they want to do or buy—but also by information about any number of distractions. Such persons have a difficult time attaining a desired goal, especially when time-pressed or tired.

Choice Revision—Having the opportunity to revise one's decisions leaves people less satisfied with the decision outcome.

Ubiquitouos Engagement—Millennial consumers, typically born from the early 1980s to early 2000s, tend to prefer engaging with brands on their terms—anytime, anywhere, anyhow.

Endowment Effect (also known as Divestiture Aversion)—People are averse to trading from any given status quo because humans are loss-adverse.

Fear of Choosing—People are afraid of being wrong because they fear the humiliation when making a mistake.

Unpleasantness Avoidance—People are afraid of being unhappy.

Pursuit of Happiness—People are happiest when they have physical pleasure from tasty food, warm environment, etc.; mental engagement (“flow”) from carrying out an enjoyed yet challenging activity; good social relationships; meaning from belonging to something bigger; and a sense of accomplishing tangible goals.

Pursuit of Praise—People enjoy the acceptance and praise of others.

Hyperbolic Discounting—People procrastinate to avoid making uncomfortable choices. Given two similar rewards, humans show a preference for one that arrives sooner rather than later. Humans are said to discount the value of the later reward, by a factor that increases with the length of the delay.

Need to Control—People are born with a deep rooted desire to control matters, including in some cases their environment and other individuals.

Paradox of Choice—Having too many choices can make us less likely to come to a conclusion.

Priming Effect—People's thinking is conditioned by the frequency of their exposure to a word, concept or number.

Quest for Simplicity—In order to act out a change, the activity to be done must be perceived to be simple enough to be within a person's range of ability. Simplicity includes: Time, Money, Physical Effort, Brain Cycles, Social Deviance, and Non-Routine.

Sociality of Choice—Guidance by Social Networks—People look to their social networks for information, approval, and use accountability in order to limit choice, for mutually beneficial reciprocity, and out of altruism.

Susceptibility to Bargains—People's susceptibility to bargains is one of the cognitive devices they use to simplify choice situations.

Time Pressure—People tend to make decisions faster when there is a deadline for making the choice selection.

Cultural Influences—The needs and drives of those in individualistic societies tend to be more self-centered than those in collectivist societies, focusing on improvement of the self, with self-actualization being the apex of self-improvement. In collectivist societies, the needs of acceptance and community will outweigh the needs for freedom and individuality.

Tone of Voice Response—People react to the tone of voice in the belief that it represents the attitude of the speaker toward them.

The present system thus takes these and possibly other psychographic factors and/or profiles into account in determining a preferential display for the individual user. When a person is, for example, susceptible to bargains, lives to work, and reacts to tones of voices, the system may determine that a simple layout, with less expensive products displayed first, and an option to hear a description of the product in a soothing voice is called for. Alternately, if a user is determined to have agoraphobic predispositions, desires choice revision capability, and has a need to control, the user may be presented with an ability to make selections and place them in a “cart” or location such that he can easily change his mind, and the user may be notified as much as possible that delivery and returns may be made from the comfort of one's home. Ordering of presentation may not be of particular note in this instance.

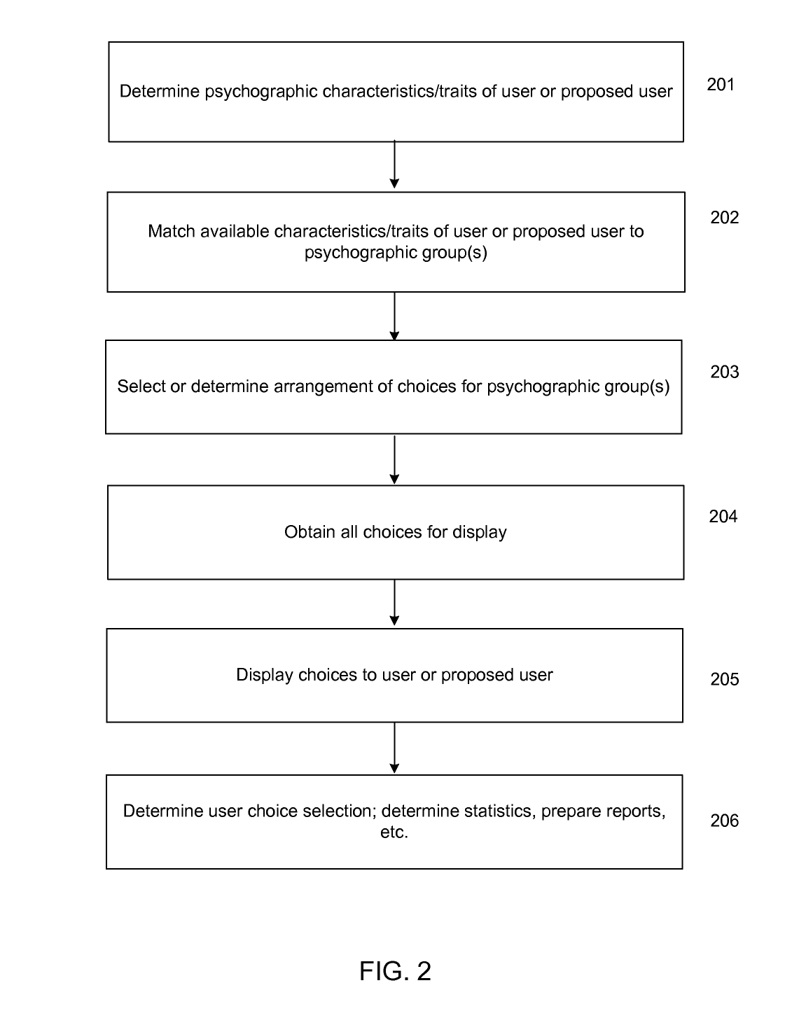

FIG. 2 illustrates the general operation of the present design. At point 201, the system determines the characteristics of either the user or a representative or expected (hypothetical) user who visits the site. Information may be collected or obtained regarding a particular user, such as her browsing history, prior purchases with the seller or with all sellers, and/or questions posed directly to the user. Partial or incomplete information may be available, and no information may be available about the user. However, if the user is adjudged to have tendencies in accordance with the psychographic groups, that information may be employed. At point 202, the system matches available characteristics of the user to psychographic groups. Such matching is and tends to be somewhat subjective. For example, if the individual is known to have purchased goods or services from the target site or from a group of sites and tends to linger for a great deal of time, browsing, then he may be considered more casual or relaxed, sharing or exhibiting tendencies in the realm of paradox of choice, cognitive control, or choice revision. An individual who always or virtually always, selects the least expensive product or service presented may share tendencies with others classified as susceptible to bargains, while persons who have visited social web sites while making decisions and/or web sites dedicated to charity, giving, or altruism may share personality characteristics with others classified in the “sociality of choice” group.

Point 203 indicates the system determines or selects the arrangement of choices for the specific psychographic group or groups identified. Point 204 obtains all information, data, and other items for display, and at point 205, the arranged display, individualized for the user or hypothetical user, is provided to the user.

Measured or assessed factors may be anything that facilitates characterizing a person as belonging to a group or groups. Weightings may be employed. As an example, user browsing history, time previously taken by the user to make decisions, total time previously spent on a web site or sites, items previously purchased, prices of items purchased previously, relative prices of previous purchases compared against items viewed, preferred colors, brands, or other preferred factors (size, etc.) Other more subtle factors may be evaluated, such as the font type or background color of the page used when the decision was made. Objective factors may be employed, such as determinations of a user's gender, age, location, income level, and so forth. In essence, as much of a profile as can be determined based on information available, including information previously available about this user, may be employed in placing him or her in an appropriate psychographic group.

Further, the user may answer a series of questions, either all at once or over time, to help classify him in a particular psychographic group. Questions such as “Would you consider yourself interested more in low price or high value?”, “Would you like to watch videos of selected items before purchasing?”, “Would you like to speak with a company representative about any question you have about an unclear item?”, “How many children do you have?”, or any other question on any other subject may be posed to the user as deemed appropriate and relevant under the circumstances. Responses may be employed to further determine an appropriate psychographic category. Assumptions may be made, and those assumptions may be incorrect. For example, if the only information regarding a user is that he is male and in the 25-35 year age range, the information provided to him may be directed to persons in that group. As an example, the user may be presented with what is believed to be a “masculine” type background designed to foster decisions for males in the 25-35 year old age bracket, but one particular user may find such colors distracting, or he may be color blind and be unable to read certain information. However, the system seeks to collect as much information as possible and places the information in a determined manner before the user. A default profile may be provided, i.e. a set of information or web pages or choice order that is presented when no information is available.

In certain situations, contrary information may be received. For example, a user may be price sensitive, may have chosen the lowest price item presented the last 43 out of 43 times, and may exhibit other price sensitive tendencies—always requiring free shipping, etc. However, on his 44^{th} visit, he may purchase the most expensive item presented and may pay a premium for overnight shipping. Certain weightings may be applied—for example, a weighting as to how many times a user acts in a certain way or exhibits a particular tendency, with a heavier weighting toward the tendency more frequently observed. Alternately, a weighting may be applied to information of greater interest, such as a higher weight being accorded to the user's gender than the user's age. Any combination of weighting schemes may be employed. Further, as noted, a user may belong to one or more psychographic groups. For example, a user may be a 35.5 per cent time pressure individual and a 64.5 per cent cognitive control person, and these may be weighted or factored into the display determination. People may embody conflicting psychographic characteristics.

Information may alternately or additionally be obtained from third party sources. For example, knowing the user's identity, the system may seek additional information regarding the user, such as from affiliates or public sources. This information may be used to supplement the user profile.

At the end of the initial phase, the system has as much information as possible regarding the user and his or her psychographic tendencies and/or grouping(s). The system then proceeds with the second phase of operation, namely presenting items in a manner determined to be preferable for the user. As may be appreciated, users who have urgency to purchase and do not linger on a site may be presented with a simple, limited arrangement, with most likely purchases prominently featured. Those who like to shop or linger or take time to make considerations may be presented with a variety of options in a visually pleasing arrangement. Those who like to consult with social networks may be presented with various buttons connecting them to social websites, while those who have left little information (female, two children) are matched with “most likely” presentations or a default presentation.

Presentations may be determined based on psychographic groups, and a user belonging to a psychographic group will receive a display or arrangement in accordance with that psychographic group. In certain instances, a system may be configured to provide different combinations of arrangements for persons exhibiting characteristics in more than one psychographic profile. For example, if a person is determined to fit psychographic profile F (20 per cent) and psychographic profile W (35 per cent) and psychographic profile Y (45 per cent), the system may display the graphics associated with profile F (background, color scheme), ordering according to profile W (six per page, most attractive photographs first) and item descriptions and selection options according to profile Y. Specialized determinations and desired combination arrangements may be made before the user visits the site. Different arrangements may be employed at different times of day, on different days, or under any of a variety of circumstances depending on the determinations made.

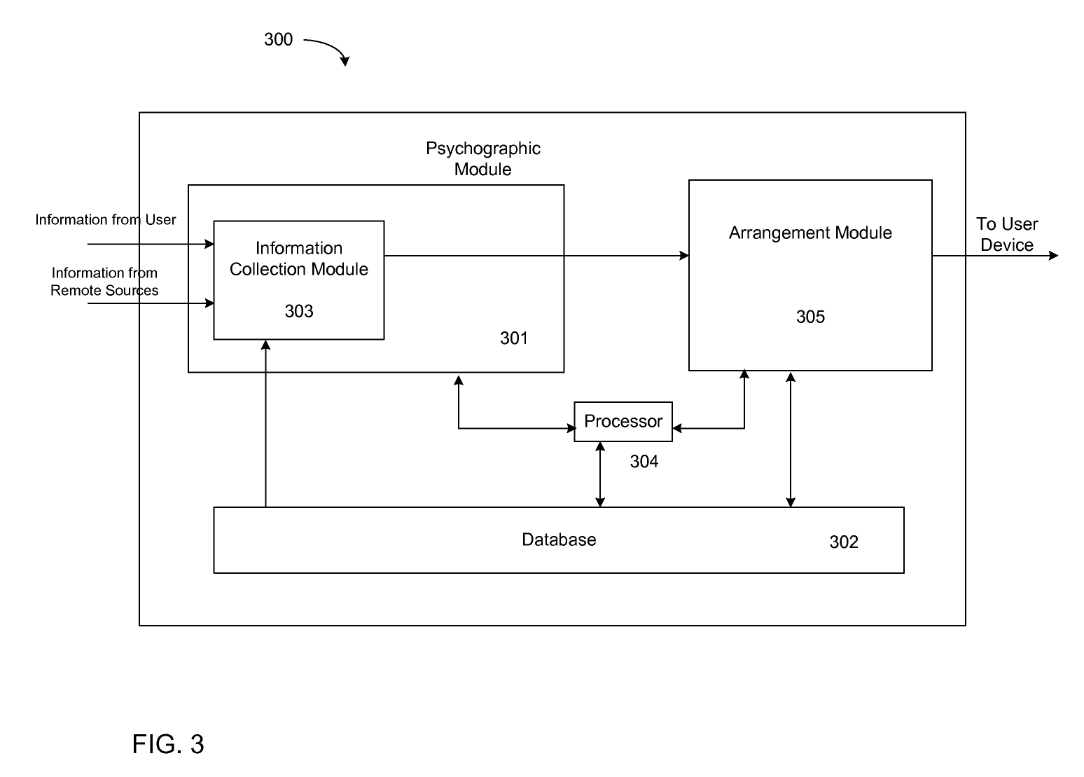

The system 300 may include a psychographic module such as is shown in FIG. 3. The psychographic module 301 may be part of the system and may be part of the remote device 103 in FIG. 1. The psychographic module receives information from the user via the user device, from the history for the particular user available to the remote device, such as from a database 302 as shown in FIG. 3, and/or from any remote sources. Psychographic module 301 includes an information collection module 303 that collects the information, a processor 304 that processes all available information about the user relative to any appropriate psychographic group or groups (weightings, priorities, determining whether multiple groups are warranted) and determines a user profile. The user profile passes to the arrangement module 305, also connected to the processor 304, and arrangement module 305 determines, based on the user profile, how and under what conditions information is to be transmitted to the user.

The arrangement module 305 seeks the appropriate arrangement information for the psychographic group or groups from database 302, including type of display, information to be displayed, arrangement, colors, fonts, styles, widgets, and so forth. The arrangement module 305 also retrieves the raw information regarding the items available, e.g. products, services or information or desired display items for display to the user according to the arrangement determined, using the processor 304. In essence, the arrangement module takes the psychographic group information, determines appropriate arrangement information based on the psychographic group information, obtains the desired choices, and the processor 304 and arrangement module 305 collectively operate to determine the specific arrangement for the specific user based on her psychographic profile and obtain and provide the arrangement to the user.

Information regarding selections, users, psychographic profiles, and everything related to the process may be collected and retained. Information collected may be analyzed and certain information, such as psychographic group profiles, user data, selections made, time required to make selections, and so forth may be used to determine psychographic groups and preferred arrangements and ordering of items. For example, if psychographic profile X corresponds to 259 users, and a large number of those 259 users make selections when a red background is presented but very few make selections under the same conditions when a blue background is present, such information may be employed to determine a red background is to be provided to users belonging to psychographic profile X. If user #108 from psychographic profile X is presented with a red background, and she does not select any of the options when she had previously made a selection when a blue background was present (she selects contrary to other users in her psychographic group), that information may be stored and user #108 may be presented with a blue background in subsequent visits.

While discussed as operating statically, i.e. the remote device obtains arrangements that have been prepared, changes may be made dynamically, such as the foregoing user #108 preferring a blue background, and being presented with a blue background during a session.

An alternate attribute of the present design is that depending on the pattern of travel within the website and/or the amount of dwell time at specific page locations within the website, the system may prompt the user to take particular actions. For example, a graphic may be displayed: “Did you want to see what the version from entity C looks like?” and selecting this option may guide the user to the version from entity C. The user may alternately be presented with a suggestion—“You have contributed $300 in the past year to the cause. Would you like to contribute more this year—$400, $500, or $1000 (platinum level)?” The remote device may make changes to the set of choices offered, and may give instructions to the user depending on the user actions on the site. For example, if the user was browsing and lingering on choice selections but appears to be rapidly attempting to go through options, the user may be presented with a single choice, and a graphic that says “You appear to be ready to make your final decision. We believe, based on our knowledge of you, the following might be a terrific selection—the ABCD Ice Cream Scoop—click here to select this choice and check out” while showing the user a single choice. Alternately, the system may determine that while you appear normally to be highly price sensitive, today you are not price sensitive, and the site may display appropriate choices irrespective of cost, essentially overriding your psychographic profile based on activity. In essence, any type of altered display of information or arrangement may be employed depending on circumstances encountered.

One example of the present design may be employed in a system for performing transaction resolution, such as debt collection, an example of which is provided in U.S. Pat. Nos. 8,504,468 and 8,510,214, inventors G. Christopher Imrey, et al., the entirety of which are incorporated herein by reference. In this type of arrangement, the present design may assess the ability of the user to pay as well as her psychographic profile, and may prepare a transaction settlement offer set including at least one and typically more than one offer to settle a transaction, and may present the transaction offer settlement set in a manner determined to result in likely settlement for the individual user based on her psychographic profile. As noted, the arrangement presented may be statically determined (e.g. transaction settlement offer set N may be provided for user 10348 based on her fitting psychographic profile N) or may be dynamically determined, and user prompting may be employed.

The system may also operate in a slightly different manner, using the same general components. In an alternative mode of operation, a particular item, choice, or selection may be identified, where the item, choice, or selection is preferred by the offering entity. In the case of an item, the item may be determined as applicable to a particular psychographic group or groups, and may be presented to users known to have psychographic factors in that psychographic group in a manner determined likely for the hypothetical user to select the item. For example, if the user is a member of psychographic group J, and users in psychographic group J are disposed to purchase smoothies when presented with a coupon, and the offeror wishes the user to purchase a smoothie at her shop during the week, the user may be offered a coupon for a half price smoothie on Wednesdays at the offeror's shop. Other users in other psychographic groups not disposed to use coupons, or purchase smoothies, may not be presented with such an offer.

The present design may therefore be considered to include a system for facilitating user selection of items, including a computing device comprising a psychographic group module configured to determine psychographic factors of a user and based on the psychographic factors of the user, categorize the user as belonging to a psychographic group, and an arrangement module configured to determine a preferred arrangement of items directed to the user based on the user belonging to the psychographic group and provide the preferred arrangement of items to the user.

Alternately, the present design may be considered to include a method for facilitating user selection of items. The method may include determining, at a computing device, psychographic factors of a user, at the computing device, categorizing the user as belonging to a psychographic group based on determined psychographic factors of the user, at the computing device, determining a preferred arrangement of items directed to the user based on the user belonging to the psychographic group, and providing the preferred arrangement of items to the user. The providing is from the computing device to a user device.

While the present design has been discussed with respect to making selections from a web site, it is to be understood that such collections may be retail purchasing selections, but may also apply in other scenarios, including but not limited to charitable donations, government programs, educational/academic situations, and any situation where a user is employing a computing device to make a selection and a party offering the options wishes to facilitate the selection, either by influencing the selection or rapidly matching the user to a preferred selection in a most efficient way. The present system and method may be substantially or completely internet based such that the user can access the remote device to make a selection or selections from a platform providing, for example, Internet browsing capabilities.

The foregoing description of specific embodiments reveals the general nature of the disclosure sufficiently that others can, by applying current knowledge, readily modify and/or adapt the system and method for various applications without departing from the general concept. Therefore, such adaptations and modifications are within the meaning and range of equivalents of the disclosed embodiments. The phraseology or terminology employed herein is for the purpose of description and not of limitation.

1-2. (canceled)

3. A system for facilitating user selection of items, comprising:
a processor;
a storage device configured to maintain user information comprising interests, activities, and opinions (IAO) of the user, browsing history, prior purchases, and questions posed directly to the user, the storage device further configured to maintain arrangement information for a plurality of psychographic groups, including type of display, information to be displayed, arrangement of colors, fonts, styles and widgets;
an information collection module, collectively with the processor, configured to collect information from a user, remote sources, and the storage device, the information collection module further configured to pose direct questions to a user;
a psychographic group module, collectively with the processor, configured to determine psychographic factors of a user via information collected from the user by the information collection module and based on the psychographic factors of the user, including fears, aspirations, desires, goals, tendencies, and generosity of the user, apply weightings, priorities and IAO to the psychographic factors of the user, and categorize the user as belonging to at least one of a plurality of psychographic groups;
an arrangement module, collectively with the processor, configured to obtain information regarding the items to be displayed, obtain a type of display of the user from the storage device, and determine a preferred arrangement of items directed to the user based on the items to be displayed, the type of display and the user belonging to the at least one of the plurality of psychographic groups; and
a transmitter configured to provide the preferred arrangement of items as determined by the arrangement module to a device associated with the user.

4-5. (canceled)

6. The system of claim 3, wherein the arrangement module is configured to determine a simple layout as the preferred arrangement of items when the psychographic group module determines the user's psychographic profile indicates a preference for the simple layout.

7. The system of claim 3, wherein the arrangement module is configured to determine an arrangement by price or cost of each item directed to the user.

8. The system of claim 3, wherein the system further comprises a timer and the user device is configured to assess user response time and prompt the user when the user is taking more time than a predetermined time value based on time received from the timer.

9. The system of claim 3, wherein the arrangement module is configured to determine at least one color in the preferred arrangement of items directed to the user based on user categorization by the psychographic group module.

10. The system of claim 3, wherein the preferred arrangement of items directed to the user comprises at least one item, choice, or selection determined by an offering entity.

11-22. (canceled)
